(19) United States
(12) Patent Application Publication
(10) Pub. No.: US 2021/0256483 A1
(43) Pub. Date: Aug. 19, 2021

(54) SYSTEM AND METHOD FOR PROVIDING HVAC SALES / SERVICES

(71) Applicant: Carrier Corporation, Palm Beach Gardens, FL (US)

(72) Inventors: Nicholas S. Arch, Palm Beach Gardens, FL (US); Mark J. Ladd, Palm Beach Gardens, FL (US); Anthony Luk, Palm Beach Gardens, FL (US); Antoine Veliz, Palm Beach Gardens, FL (US); Jessica L. Roach, Palm Beach Gardens, FL (US); William Mackie, Palm Beach Gardens, FL (US); Lisa A. Mitchell, Palm Beach Gardens, FL (US); Mary Rockwell, Palm Beach Gardens, FL (US)

(21) Appl. No.: 17/251,379

(22) PCT Filed: Dec. 12, 2019
(86) PCT No.: PCT/US2019/065846

§ 371 Date: Dec. 11, 2020

Related U.S. Application Data
(60) Provisional application No. 62/778,496, filed on Dec. 12, 2018.

(51) Int. Cl. G06Q 10/00; G06Q 10/06; G06Q 30/02

(52) U.S. Cl. CPC G06Q 10/20; G06Q 30/0283; G06Q 10/06311

(57) ABSTRACT

A system for providing heating ventilation and cooling (HVAC) services includes a central server having an HVAC services module. The central server is communicatively coupled to at least one database, a credit system, a payment processing system, and an installation and maintenance scheduling system. The central server includes instructions configured to cause the central server to receive a residence identifier from a user portal, determine an estimated HVAC load of a building corresponding to the residence identifier, provide a user with a cost estimate based on the estimated HVAC load, and process a payment received from the user wherein the payment is based on the cost estimate.

### CROSS-REFERENCE TO RELATED APPLICATIONS

This application claims priority to U.S. Provisional Application No. 62/778,496, which was filed on Dec. 12, 2018 and is incorporated herein by reference.

### TECHNICAL FIELD

The present disclosure relates generally to a system and method for providing residential HVAC (heating, ventilation, and cooling) sales and services, and more specifically towards an automated method providing transparency to an end user.

### BACKGROUND

Current residential HVAC manufacturers operate through regional or local dealers, each of whom has their own independent practices and procedures. In addition, multiple regional dealers can operate within a single region, resulting in widely disparate procedures for a homeowner looking to add or replace an HVAC system or acquire services for the HVAC system. The cost of HVAC equipment and services is typically hidden behind initial consultations and estimates and is not ascertainable before the contractor has been selected.

### SUMMARY OF THE INVENTION

In one exemplary embodiment, a system for providing heating ventilation and cooling (HVAC) services includes a central server including an HVAC services module, the central server being communicatively coupled to at least one database, a credit system, a payment processing system, and an installation and maintenance scheduling system, and wherein the central server includes instructions configured to cause the central server to receive a residence identifier from a user portal, determine an estimated HVAC load of a building corresponding to the residence identifier, provide a user with a cost estimate based on the estimated HVAC load, and process a payment received from the user wherein the payment is based on the cost estimate.

In another example of the above described system for providing heating ventilation and cooling (HVAC) services the installation and maintenance scheduling system includes at least one HVAC system monitoring module connected to a corresponding remote monitoring module of an installed HVAC system.

In another example of any of the above described systems for providing heating ventilation and cooling (HVAC) services one of the installation and maintenance scheduling system and the central server is configured to respond to an error message of the corresponding remote monitoring module by one of providing an electronic correction to the installed HVAC system and scheduling a maintenance inspection of the installed HVAC system.

In another example of any of the above described systems for providing heating ventilation and cooling (HVAC) services the user portal is one of a website and a mobile device application.

In another example of any of the above described systems for providing heating ventilation and cooling (HVAC) services the at least one database includes a plurality of entries, each entry corresponding to a unique residence and each entry including at least two of a geographic location, square footage, basement square footage, finished square footage, number of floors, number of fireplaces, type of insulation, gross area, garage area, year built, number of systems, heat type, and fuel type.

In another example of any of the above described systems for providing heating ventilation and cooling (HVAC) services the credit system is a credit monitoring system configured to verify a creditworthiness of the user.

In another example of any of the above described systems for providing heating ventilation and cooling (HVAC) services the payment processing service is an independent payment processing service connected to the central server.

In another example of any of the above described systems for providing heating ventilation and cooling (HVAC) services the at least one database includes a first database and a second database, and wherein each of the first database and the second database includes data not included in the other of the first database and the second database.

An exemplary method for providing HVAC installation and monitoring services includes receiving a unique residence identifier from a user, retrieving data correlated with the unique residence identifier from at least one database, determining an estimated HVAC load based on the retrieved data, and providing an estimated installation and maintenance cost of HVAC systems and services based on the estimated HVAC load.

In another example of the above described exemplary method for providing HVAC installation and monitoring services retrieving data correlated with the unique residence identifier from that least one database comprises prompting a user requesting HVAC installation and maintenance to review and correct the retrieved data.

Another example of any of the above described exemplary methods for providing HVAC installation and monitoring services further includes verifying a financial credit of a user requesting HVAC installation and maintenance services, thereby determining an ability of the user to afford the estimated installation and maintenance costs.

Another example of any of the above described exemplary methods for providing HVAC installation and monitoring services further includes receiving a payment from the user and initiating an HVAC systems installation process in response to receiving the payment.

In another example of any of the above described exemplary methods for providing HVAC installation and monitoring services initiating the HVAC system installation process includes scheduling n HVAC system installation.

Another example of any of the above described exemplary methods for providing HVAC installation and monitoring services further includes installing the HVAC system according to the scheduling HVAC system installation.

Another example of any of the above described exemplary methods for providing HVAC installation and monitoring services further includes continuously monitoring the installed HVAC system after installation.

Another example of any of the above described exemplary methods for providing HVAC installation and monitoring services further includes verifying a user's payment status in response to receiving an error notification from the installed HVAC system.

Another example of any of the above described exemplary methods for providing HVAC installation and monitoring services further includes responding to the error notification by providing an electronic adjustment to the installed HVAC system when the user's payment status is up to date.

Another example of any of the above described exemplary methods for providing HVAC installation and monitoring services further includes responding to the error notification by scheduling a technician for maintenance on the installed HVAC system when the user's payment status is up to date.

These and other features of the present invention can be best understood from the following specification and drawings, the following of which is a brief description.

### BRIEF DESCRIPTION OF THE DRAWINGS

FIG. 1 schematically illustrates an environment for providing HVAC sales and services.

FIG. 2 illustrates a process for acquiring HVAC systems and services through the system illustrated in FIG. 1

FIG. 3 illustrates a process for providing continued services and maintenance of HVAC systems through the system illustrated in FIG. 1.

### DETAILED DESCRIPTION

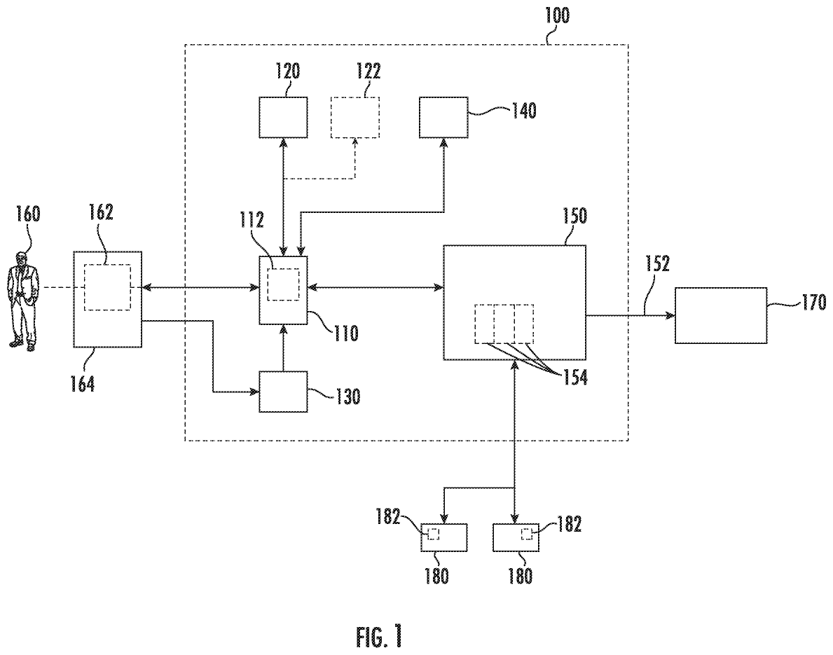

FIG. 1 schematically illustrates a system 100 for providing HVAC services. The system 100 is a computerized system including a central server 110 operating an HVAC services module 112. The central server 110 is communicatively coupled to one or more residential information databases 120, 122, each of which contains details about residential buildings. By way of example, the databases 120, 122 can include details such as geographic location, square footage, basement square footage, finished square footage, number of floors, number of fireplaces, type of insulation, gross area, garage area, year built, heat type, fuel type, number of systems, etc. The central server 110 is also communicatively coupled to a payment processing service 130, a credit system 140, and an installation and maintenance scheduling system 150.

The HVAC services module 112 can be accessed by a user 160 through a website 162 operating on a computing device 164. In alternative examples, the website 162 may be replaced with an application, a program, or any similar computerized module allowing the user 160 to interface with the central server 110 and initiate acquisition of HVAC services.

The HVAC services module 110 is also connected to the installation and maintenance scheduling system 150, and automatically engages licensed contractors to perform HVAC installation and monitoring services. The installation and maintenance scheduling system 150 provides an output 152 to independent contractor systems 170 to order physical installation and maintenance of the HVAC systems.

In some examples, the installation and maintenance scheduling system 150 can include HVAC systems monitoring modules 154. The HVAC systems monitoring modules 154 receive data from remote HVAC systems 180 that have been installed in a residential building. By way of examples, each of the HVAC systems 180 can include a remote monitoring module 182 as either hardware or software, and the remote monitoring module 182 can provide diagnostic and operational data of the HVAC system 180 to the HVAC systems monitoring modules 154.

The HVAC systems monitoring modules 154 can then determine any number of malfunctions, maintenance needs, routine adjustments and the like based on the actual received diagnostic data. Once a need has been determined, the corresponding HVAC system monitoring module 154 can either provide an automatic adjustment, when control settings need to be tweaked, or schedule a contractor visit when physical maintenance is required.

During practical operation of the system 100 for providing HVAC services, all of the operations and features within the system 100 are invisible to the end user 160, allowing for a simplified and easier to understand procedure for acquiring HVAC services.

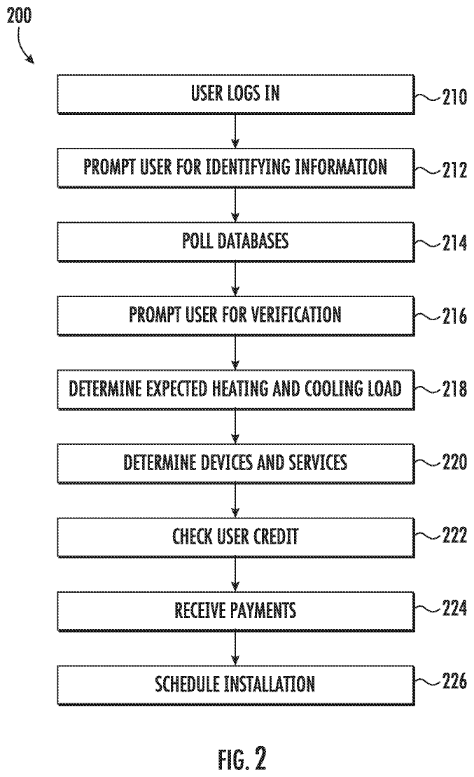

With continued reference to FIG. 1, FIG. 2 illustrates a process 200 for acquiring HVAC systems and services through the system 100 illustrated in FIG. 1. Initially, the user 160 logs into the website 162 using their device 164 in a “User Logs In” step 210. The user log in can include logging into an account via a password protection, two factor authentication, or any other form of user verification. If the user 160 already has an account created, the website 162 returns the user 160 to the state where the user was when they previously logged out. If the user 160 does not already have an account created, the website proceeds with the process described herein, and prompts the user 160 to create an account after the system 100 has determined what devices and services are required.

Alternatively, the user log in can be on an ad-hoc basis with each log in being treated as a wholly independent event.

Once logged in, the user is prompted to provide the central server 110 with identifying information corresponding to the building that the user 160 is seeking HVAC services for in a “Prompt User For Identifying Information” step 212. The identifying information can be any form of information that allows the central server 110 to identify the specific building that the user 160 is requesting HVAC services for. By way of example, this information can take the form of a street address, a subdivision lot number, or any other unique identifier.

Once the central server 110 has received the unique identifier, the HVAC services module 112 polls one or more databases 120, 122 for details regarding the identified building in a “Poll Databases” step 214. The information pulled from the databases 120, 122 can include square footage of the building, number of fireplaces in the building, finished square footage, unfinished square footage, number of bedrooms, regional climate, gross area, garage area, year built, number of systems, or any similar information that is mathematically correlated with expected heating and cooling loads.

The determined information is provided to the user 160 in a “Prompt User for Verification” step 216 through the website 162. If the user 160 disagrees with any of the determined information, or has additional information that was not included in the databases 120, 122, the user 160 is able to update the HVAC services module 112 with new information

Once the information has been retrieved, and any corrections or updates have been provided by the user 160, the HVAC services module 112 determines an expected heating and cooling load in a “Determine Expected Heating and Cooling Load” step 218. The expected heating and cooling load can be determined using any known load determination process, and takes place automatically within the central server 110. By way of example the load determination can be a process that relates one or more of the data points in the retrieved information to a cooling load.

Once the load has been determined, the HVAC services module 112 uses the load to determine what HVAC devices and what HVAC services are required for the residence in a “Determine Devices and Services” step 220. Included within the step 220 is a cost calculation for the purchase, installation, and upkeep of the necessary devices. Once the cost has been calculated, the cost is provided to the user 160 through the website 162. The cost can be displayed as either a single lump fee, a monthly rate for continued service (i.e. a subscription fee), or a combination of the two. In either event, the fee presented represents the entirety of the cost borne by the user 160 for installation and maintenance of the HVAC systems for a predetermined time period. In some examples, the predetermined time period can be 5 years, 10 years, the expected life of the HVAC systems, or any other suitable length of time.

If the user agrees to the identified cost(s), the HVAC services module 112 connects with a credit database to determine if the user has a sufficient credit score, or other credit metric, to bear the agreed cost in a “Check User Credit” step 222. If the user's credit is sufficient, the HVAC services module 112 notifies the user 160 that payments can commence, and processes the payments using the payment processing module in a “Receive Payments” step 224.

Once the initial payment(s) have been received, the HVAC services module 112 uses the installation and maintenance scheduling system 150 to reserve parts, and schedule a licensed and approved contractor in the area to install and maintain the HVAC system in a “Schedule Installation” step 226. During the schedule installation step 226, the necessary parts, relevant customer information, dwelling details, system information, and any other pertinent pieces of information are provided to the independent contractor system 170 of the contractor performing the installation and maintenance, allowing the contractor to install the HVAC system.

In some cases, such as those where a homeowner is unsure of housing details and/or the databases 120, 122 include incorrect information that is not corrected by the user 160, the HVAC services module 112 can include a modification feature that allows a contractor to update the information after or during the installation of the HVAC systems. Once updated, the HVAC services module 112 updates the pricing information, and provides the updated pricing information to the user 160.

In yet further alternatives, an additional step directed toward manually reviewing the provided information prior to determining the pricing can be incorporated. Such a step can be as limited as manually reviewing the data pulled from the databases 120, 122 and updated by the user 160, or as extensive as scheduling a technician to visit the residence and verify information and/or measure details about the residence. In either case, systems including the manual review can delay installation until after any adjustments to the pricing are verified by the user 160.

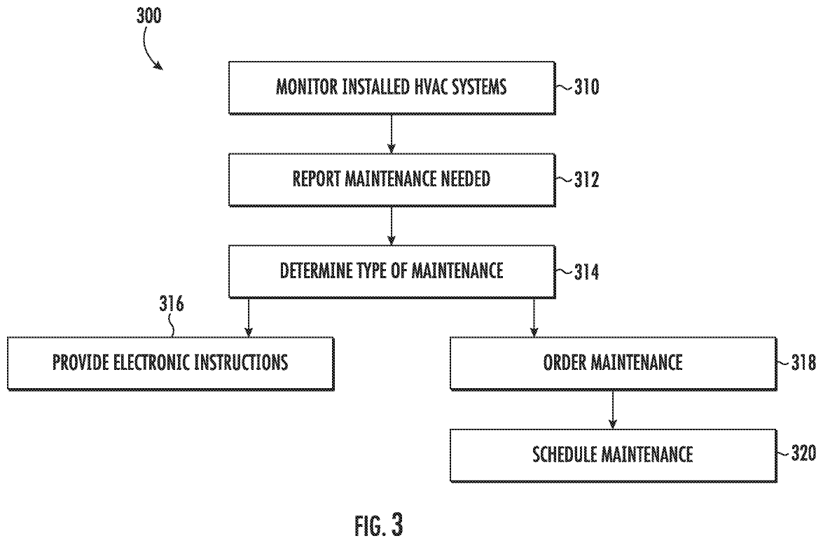

Once fully installed, some exemplary systems 100 for providing HVAC services include an additional maintenance plan and/or upkeep. With continued reference to FIGS. 1 and 2, FIG. 3 illustrates operation of the system 100 for providing HVAC services to provide continued maintenance and services after the initial installation.

To facilitate the continued monitoring, each HVAC system 180 includes one or more monitoring modules 182 that monitoring parameters of the HVAC system 180 and report the parameters to the installation and maintenance scheduling system 150 in a “Monitor Installed HVAC Systems” step 310. When the monitoring modules 182 detect that maintenance is needed on the HVAC system, the corresponding maintenance module 182 reports the maintenance required to the installation and maintenance scheduling system 150 in a “Report Maintenance Needed” step 312. The report provided by the monitoring module 182 can, in some examples, include specifics as to the type of maintenance required either via the use of error codes, plain language descriptions, or any other means of identifying the specific error.

Once the error is reported, installation and maintenance scheduling system 150 determines whether the error is one that can be corrected is software, or if it requires a manual repair in a “Determine Type of Maintenance” step 314.

When the maintenance required can be achieved via a software update, or other electronic adjustment, the installation and maintenance scheduling system 150 responds by providing instructions to the HVAC system 180 through a network in a “Provide Electronic Instructions” step 316., such as the internet, and the instructions can either correct the error or cause the HVAC system to download error correction software from another source.

When the maintenance cannot be achieved via remote means, or the installation and maintenance scheduling system 150 is unable to determine what specific maintenance is required, the installation and maintenance scheduling system 150 outputs a maintenance call to the corresponding independent contractor system 170 in a “Order Maintenance” step 318.

Once ordered, the independent contractor coordinates with the user 160 through the website 162 and determines a time during which a maintenance technician can access the error and or correct the error in a “Schedule Maintenance” step 320.

By utilizing the above system and methods, the customer (user 160) is presented with a substantially simplified set of decisions, and with the results of calculations that typically take a professional to complete. This allows the user 160 to more easily understand the offerings and costs associated with the requested HVAC system, as well as the expected continued upkeep costs of the system.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A system for providing heating ventilation and cooling (HVAC) services comprising:
a central server including an HVAC services module, the central server being communicatively coupled to at least one database, a credit system, a payment processing system, and an installation and maintenance scheduling system; and
wherein the central server includes instructions configured to cause the central server to receive a residence identifier from a user portal, determine an estimated HVAC load of a building corresponding to the residence identifier, provide a user with a cost estimate based on the estimated HVAC load, and process a payment received from the user wherein the payment is based on the cost estimate.

2. The system of claim 1 wherein the installation and maintenance scheduling system includes at least one HVAC system monitoring module connected to a corresponding remote monitoring module of an installed HVAC system.

3. The system of claim 2, wherein one of the installation and maintenance scheduling system and the central server is configured to respond to an error message of the corresponding remote monitoring module by one of providing an electronic correction to the installed HVAC system and scheduling a maintenance inspection of the installed HVAC system.

4. The system of claim 1, wherein the user portal is one of a website and a mobile device application.

5. The system of claim 1, wherein the at least one database includes a plurality of entries, each entry corresponding to a unique residence and each entry including at least two of a geographic location, square footage, basement square footage, finished square footage, number of floors, number of fireplaces, type of insulation, gross area, garage area, year built, number of systems, heat type, and fuel type.

6. The system of claim 1, wherein the credit system is a credit monitoring system configured to verify a creditworthiness of the user.

7. The system of claim 1, wherein the payment processing service is an independent payment processing service connected to the central server.

8. The system of claim 1, wherein the at least one database includes a first database and a second database, and wherein each of the first database and the second database includes data not included in the other of the first database and the second database.

9. A method for providing HVAC installation and monitoring services comprising:
receiving a unique residence identifier from a user;
retrieving data correlated with the unique residence identifier from at least one database;
determining an estimated HVAC load based on the retrieved data; and
providing an estimated installation and maintenance cost of HVAC systems and services based on the estimated HVAC load.

10. The method of claim 9, wherein retrieving data correlated with the unique residence identifier from that least one database comprises prompting a user requesting HVAC installation and maintenance to review and correct the retrieved data.

11. The method of claim 9, further comprising verifying a financial credit of a user requesting HVAC installation and maintenance services, thereby determining an ability of the user to afford the estimated installation and maintenance costs.

12. The method of claim 9, further comprising receiving a payment from the user and initiating an HVAC systems installation process in response to receiving the payment.

13. The method of claim 12, wherein initiating the HVAC system installation process includes scheduling n HVAC system installation.

14. The method of claim 13, further comprising installing the HVAC system according to the scheduling HVAC system installation.

15. The method of claim 14, further comprising continuously monitoring the installed HVAC system after installation.

16. The method of claim 15, further comprising verifying a user's payment status in response to receiving an error notification from the installed HVAC system.

17. The method of claim 16, further comprising responding to the error notification by providing an electronic adjustment to the installed HVAC system when the user's payment status is up to date.

18. The method of claim 16, further comprising responding to the error notification by scheduling a technician for maintenance on the installed HVAC system when the user's payment status is up to date.
